(19) United States
(12) Patent Application Publication
(10) Pub. No.: US 2008/0307904 A1
(43) Pub. Date: Dec. 18, 2008

(54) Liquid Specimen Sampling System and Method

(75) Inventors: Norman J. Pressman, Glencoe, IL (US); William J. Mayer, South Barrington, IL (US)

Correspondence Address: FOLEY AND LARDNER LLP;SUITE 500, 3000 K STREET NW, WASHINGTON, DC, 20007, US

(73) Assignee: MONOGEN, INC.

(21) Appl. No.: 11/667,253

(22) PCT Filed: Nov. 10, 2005
(86) PCT No.: PCT/US2005/040764

§ 371 Date: Mar. 26, 2008

Related U.S. Application Data
(60) Provisional application No. 60/626,441, filed on Nov. 10, 2004.

(51) Int. Cl. G01N 1/14; B65H 1/00

(52) U.S. Cl. 73/864.11; 73/864.62; 414/806; 414/222.07

(57) ABSTRACT

Method and system for obtaining a liquid sample from a particulate matter-containing liquid in, e.g., a specimen container. A receptacle is used that has an inlet and a chamber for collecting the liquid sample. A discharge passage accommodates upward flow of liquid from the container. The discharge passage preferably has an upper discharge port, and at least one intake submerged in the liquid in the container. A flow-metering passage prevents particulate matter above a predetermined size from passing into the receptacle chamber. Liquid transfer commences after the receptacle inlet is placed in liquid-tight communication with the discharge port. Operation of mechanized system also is disclosed, as well as an arrangement and method for handling multiple receptacles at a liquid transfer station.

### CROSS-REFERENCE TO RELATED APPLICATIONS

This application claims the benefit of U.S. provisional application No. 60/626,441, filed Nov. 10, 2004. This application also is a continuation-in-part of international application No. PCT/US04/37249, filed Nov. 9, 2004; and is a continuation-in-part of U.S. application Ser. No. 10/274,381, filed Oct. 21, 2002 (US 2003/0087443 A1). These three applications are incorporated herein by reference.

### TECHNICAL FIELD

The present invention is directed to the collection and processing of liquid specimens for subsequent testing or analysis, e.g., biological fluid specimens, such as used in cytology or molecular diagnostic protocols, or non-biological specimens, such as drinking water containing impurities.

### BACKGROUND

US 2003/0087443 A1 discloses an example of an automated (computer-controlled) apparatus for handling specimen vials. The apparatus may be referred to as an “LBP” processor (for liquid-based preparation), and can be integrated into a complete automated laboratory system.

FIG. 1 (a schematic top plan view) shows the overall arrangement of the automated processor disclosed in US 2003/0087443 A1. The LBP processor transports multiple specimen vials sequentially through various processing stations and produces fixed specimens on slides, each slide being bar-coded and linked through a data management system (DMS) to the vial and the patient from which it came. In the preferred arrangement, each vial has a special internal processing assembly detachably coupled to its cover, and is transported through the LBP processor on a computer-controlled transport (conveyor) 240, in its own receptacle 246. (In the example shown the conveyor has thirty receptacles.) The containers and the receptacles are keyed so that the containers proceed along the processing path in the proper orientation, and cannot rotate independently of their respective receptacles.

The containers first pass a bar code reader 230 (at a data acquisition station), where the vial bar code is read, and then proceed stepwise through the following processing stations of the LBP processor: an uncapping station 400 including a cap disposal operation; a preprocessing station 500; a filter loading station 600; a specimen acquisition and filter disposal station 700; and a re-capping station 800. These six stations are structured for parallel processing, meaning that all of these stations can operate simultaneously on different specimens in their respective containers, and independently of the other. The conveyor will not advance until all of these operating stations have completed their respective tasks.

The preprocessing station is the location at which preprocessing operations, such as specimen dispersal within its container, are performed prior to the container and its specimen moving on for further handling. The preprocessing station typically performs a dispersal operation. In the preferred embodiment, the dispersal operation is performed by a mechanical mixer (stirrer), which rotates at a fixed speed and for a fixed duration within the specimen container. The mixer serves to disperse large particulates and microscopic particulates, such as human cells, within the liquid-based specimen by homogenizing the specimen. Alternatively, the specimen may contain subcellular sized objects such as molecules in crystalline or other conformational forms. In that case, a chemical agent may be introduced to the specimen at the preprocessing station to, for example, dissolve certain crystalline structures and allow the molecules to be dispersed throughout the liquid-based specimen through chemical diffusion processes without the need for mechanical agitation. Such a chemical preprocessing station introduces its dispersing agent through the preprocessing head.

There is also an integrated system 900 that includes additional bar code readers, slide cassettes, handling mechanisms for slide cassettes and individual slides, and a slide presentation station 702 at which the specimen acquisition station transfers a representative sample from a specimen to a fresh microscope slide. An optional auto loading mechanism 300 automatically loads and unloads specimen vials onto and from the transport mechanism. All stations and mechanisms are computer-controlled.

In the preferred embodiment of this LBP processor, the vial uncapping station 400 has a rotary gripper that unscrews the cover from the vial, and discards it into a biosafety disposable waste handling bag. Before discarding the cover, however, the uncapping head presses on the center of the cover as described above to detach the internal processing assembly (stirrer) from the cover. The preprocessing (mixing) station 500 has an expanding collet that grips the processing assembly, lifts it slightly and moves (e.g., spins) it in accordance with a specimen-specific stirring protocol (speed and duration). The filter loading station 600 dispenses a specimen-specific filter type into a particulate matter separation chamber (manifold) at the top of the processing assembly. The specimen acquisition station 700 has a suction head that seals to the filter at the top of the processing assembly and first moves the processing assembly slowly to re-suspend particulate matter in the liquid-based specimen. Then the suction head draws a vacuum on the filter to aspirate the liquid-based specimen from the vial and past the filter, leaving a thin layer of cells on the bottom surface of the filter. Thereafter the thin layer specimen is transferred to a fresh slide, and the container moves to the re-capping station, where a foil-type seal is applied.

The LBP processor shown in FIG. 1 also is equipped with a liquid sampling draw station 100, which is adapted to place a specially designed liquid collection receptacle into engagement with the processing assembly (stirrer) present in any of the specimen containers processed by the LBP processor. The receptacle is in the form of a molded plastic cuvette, and has a thermoplastic elastomer one-way valve on one end that mates with and seals against the upper end of the processing assembly. The valve admits liquid into the cuvette when the cuvette is placed under vacuum to draw liquid from the specimen container up through the processing assembly. The valve is otherwise sealed to prevent the escape of liquid from the cuvette. A syringe or a cannula can be used to withdraw liquid from the cuvette for testing. Preferably the cuvette is bar-coded so that it can be linked to the specimen vial and the patient identifying data through the DMS.

As illustrated in FIG. 1, the liquid sampling draw station 100 is located just after (downstream of) the mixing station 500 of the LBP processor. However, the liquid sampling draw station instead could be located downstream of the specimen acquisition station 700. Actuation of the liquid sampling draw station 100 preferably is governed by the particular processing protocol for each specimen. Accordingly, there may be specimen containers from which no liquid sample is drawn, in which case the liquid sampling draw station will remain idle while such a container dwells there. It is also possible for the liquid sampling draw station to draw a variable liquid volume, again dependent on the particular processing protocol for each specimen. To accomplish that, a plurality of vertically spaced liquid level sensors would monitor the changing level of liquid in the receptacle, and liquid draw would be terminated when the specified liquid volume is acquired.

### SUMMARY DISCLOSURE OF THE INVENTION

The invention disclosed in the present application concerns liquid sample collection in general. It also concerns a liquid sampling draw station that may be used in an LBP processor, and the liquid collection receptacles (cuvettes) that may be employed at that station. The invention further concerns operation of an LBP processor, which may be controlled with respect to an individual vial, depending on protocol, so as to draw a liquid sample from the vial at the liquid sampling draw station, and/or to draw liquid at the specimen acquisition station to make a slide-mounted sample, in either order.

A first aspect of the invention concerns methods and systems for obtaining a liquid sample containing size-restricted particulate matter from a particulate matter-containing liquid in a container. A receptacle is used that has an inlet and a chamber for collecting the liquid sample. A discharge passage accommodates upward flow of liquid from the container. The discharge passage preferably has an upper discharge port, and at least one intake submerged in the liquid in the container. A flow-metering passage prevents particulate matter above a predetermined size from passing into the receptacle chamber. The receptacle inlet is placed in liquid-fight communication with the discharge port, and particulate matter-containing liquid is caused to flow from the container upwardly through the discharge passage, through the receptacle inlet and into the receptacle chamber. The flowing liquid also passes through the flow-metering passage so that the liquid sample collected in the receptacle contains only size-restricted particulate matter.

The discharge passage, the discharge port and the intake may be in a discharge element that is associated with the container, i.e., is in, is insertable into, or is part of the container. For example, the discharge element may be the tubular portion of a processing assembly that is already in the container, or a tube that is inserted into the container just prior to sample collection, or part of the container wall. The flow-metering passage may be associated with the discharge passage or the receptacle. For example, the intake may act as the flow-metering passage; or the flow-metering passage may be a filter in the receptacle located between the inlet and the chamber for collecting the liquid sample.

Another aspect of the invention concerns a method for optionally obtaining a liquid sample and/or a particulate matter sample from a particulate matter-containing liquid specimen in a container. The method uses an apparatus comprising a liquid sampling station for collecting a liquid sample in a receptacle having a resilient tip with an inlet, and a specimen acquisition station having an aspiration head for collecting a sample layer of particulate matter separated from the liquid on a surface of a filter. The container has therein a processing assembly comprising an upper separation chamber adapted to receive a filter and a tube extending downwardly from the separation chamber into the specimen liquid in the container. The tube has a vent hole above the level of specimen liquid in the container. The method involves optionally performing one or both of the following series of steps (a) and/or (b) in either order:

(a) inserting the resilient tip of the receptacle into the upper end of the tube to form a seal with the upper end of the tube and seal off the vent hole, and applying a vacuum to the receptacle to withdraw liquid from the container through the inlet and into the receptacle;

(b) placing a filter in the separation chamber, sealing the aspiration head to the upper portion of the separation chamber, and applying a vacuum to aspirate liquid from the container through the tube and aspirate air into the tube through the vent hole, whereby particulate matter is separated from the aspirated liquid, and a sample layer of particulate matter is formed on a surface of the filter.

A further aspect of the invention concerns a method and apparatus for handling receptacles at a liquid sampling station. Each receptacle has a bottom inlet adapted to dock with an upwardly facing port through which liquid can flow. At least one carrier is used to removably hold a plurality of receptacles. The carrier is advanced along a path that extends toward and away from a liquid transfer location. One receptacle at a time is removed from the carrier. The removed receptacle is moved so as to dock the inlet of the receptacle with the port. Then the receptacle is moved so as to undock the inlet from the port, and the receptacle is returned to the carrier.

### BRIEF DESCRIPTION OF THE DRAWING FIGURES

Embodiments that incorporate the best mode for carrying out the invention are described in detail below, purely by way of example, with reference to the accompanying drawing, in which:

FIG. 1 is a schematic top plan view of an automated specimen processing apparatus with which the present invention can be used;

FIG. 2 is an elevational view of a cuvette according to the invention;

FIG. 3 is a longitudinal sectional view of the cuvette of FIG. 2;

FIG. 4 is a vertical sectional view through a specimen container and the cuvette of FIG. 2 engaged with the processing assembly;

FIG. 5 is a detail view of a portion of the container, processing assembly and cuvette shown in FIG. 4;

FIG. 6 is a perspective view of the cuvette engaged with the processing assembly of a specimen container (shown cradled in a receptacle of the LBP processor) and showing a portion of a cuvette docking mechanism according to the invention;

FIG. 7 is a perspective view of the processing assembly;

FIG. 8 is a bottom plan view of the processing assembly;

FIG. 9 is an exploded vertical sectional view of the processing assembly and a filter assembly adapted for use in the processing assembly;

FIG. 10 is a top plan view of the center portion of the bottom wall of the container according to another embodiment of the invention;

FIG. 11 is an elevational view of the lower portion of the processing assembly according to another embodiment of the invention;

FIG. 12 is a vertical sectional view of the lower portion of the processing assembly in a container taken along line 12-12 in FIG. 8;

FIG. 13 is a perspective view of the liquid sampling draw station according to the invention;

FIG. 14 is a perspective view of an LBP processor generally of the type shown in FIG. 1, and incorporating the liquid sampling draw station of FIG. 13;

FIG. 15 is a front elevational view of the LBP processor of FIG. 14;

FIG. 16 is a close-up perspective view of a portion of the LBP processor of FIG. 14;

FIG. 17 is a perspective view of the cuvette docking mechanism;

FIG. 18 is a top plan view of the cuvette docking mechanism of FIG. 17;

FIG. 19 is a perspective view of a clip according to the invention holding ten cuvettes for transport to and from the docking mechanism;

FIG. 20 is a perspective view of a transport mechanism according to the invention for transporting cuvettes to and from the docking mechanism;

FIG. 21 is a perspective view of the feeder tray for housing fresh (empty) cuvettes; and

FIG. 22 is a perspective view of the receiver tray for housing used (filled) cuvettes.

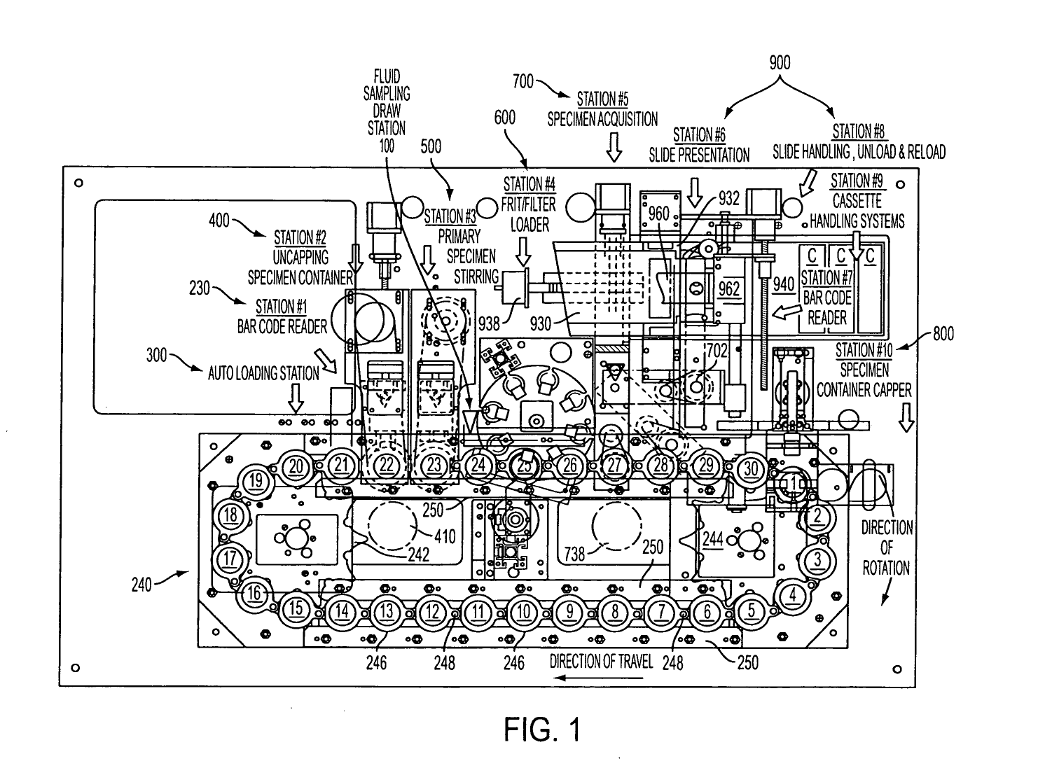

It is to be understood that the invention is not limited in its application to the details of construction and the arrangement of components of the preferred embodiments described below and illustrated in the drawing figures. Various modifications will be apparent to those skilled in the art without departing from the scope of the invention. Further, while the preferred embodiment is disclosed as primarily useful in the automated collection and processing biological fluids for cytology examination and/or analysis, it will be appreciated that the invention has manual or automated application in any field in which liquid specimens are sampled.

### DETAILED DESCRIPTION

### Cuvette Docking

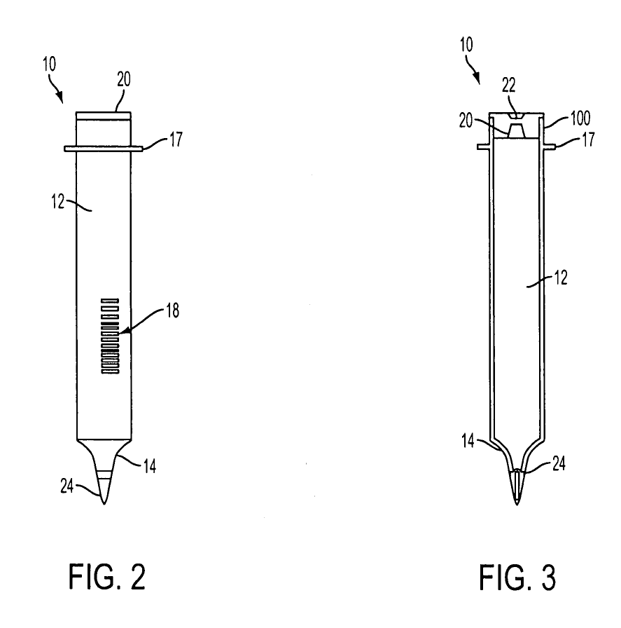

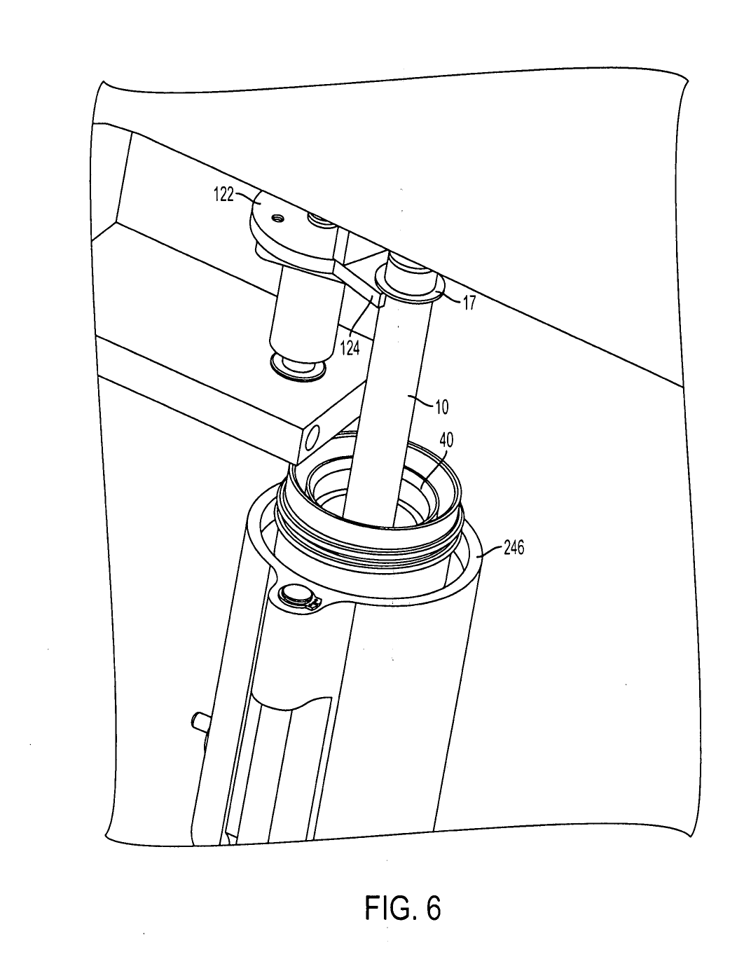

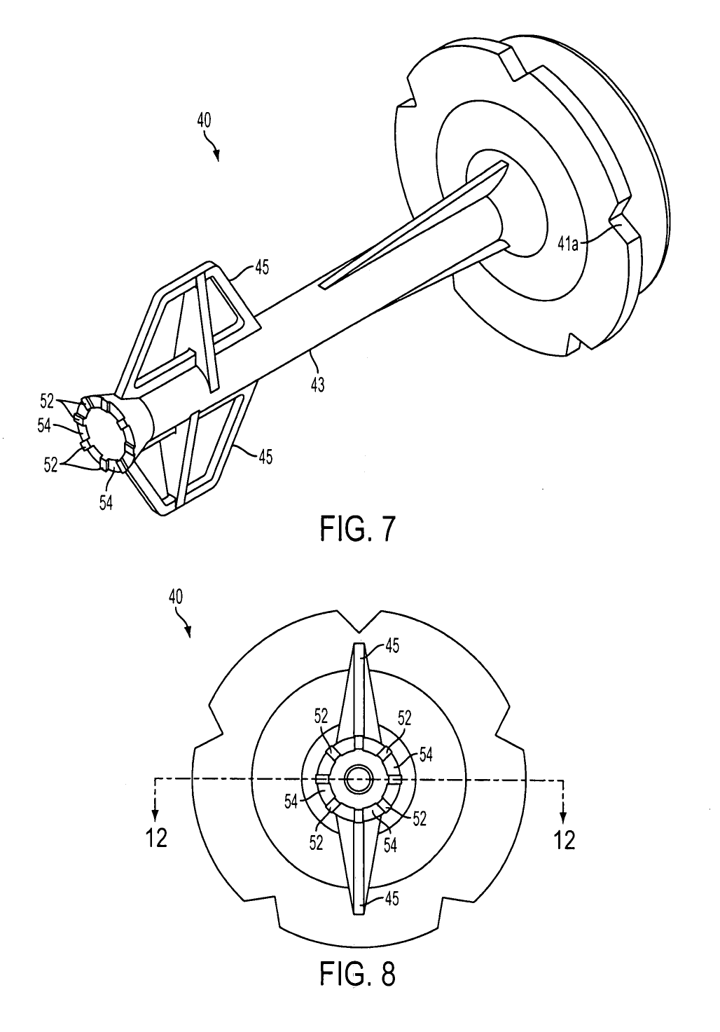

Referring to FIGS. 2-6, a cuvette 10 according to the invention has a slender cylindrical body 12 with a tapered lower end 14, an open upper end 16, and an upper collar 17. The cuvette body 12 is molded of plastic, preferably clear or translucent polyethylene, and preferably is sized to hold up to about 5 ml. of specimen liquid. A unique machine-readable bar code 18 is carried by the body 12, preferably applied by laser etching.

A thermoplastic elastomer stopper 20 permanently seals the upper end 16. Stopper 20 is molded with an integral membrane 22, which can be pierced by a cannula for both specimen aspiration and for subsequent sample withdrawal for testing or analysis. Membrane 22 is self-sealing so that it will not leak after the cannula is withdrawn.

The lower end 14 of the cuvette preferably is shaped to mate with the upper end of the processing assembly 40 of a specimen vial, and is fitted with a tapered, one-way valve 24 molded of a thermoplastic elastomer. The resilient nature of the valve material normally keeps the small flow passage 26 therein squeezed tightly shut without the potential for leakage. The valve has an exposed, tapered surface 28, the purpose of which is to act as a gasket when it is coupled to the suction tube 43 of the processing assembly (stirrer) 40 in the specimen container 30 (which is in a receptacle 246 on the conveyor of the LBP processor). The exposed surface 28 of the valve enters and positively seals against the upper end (discharge port) of the stirrer suction tube 43. It also seals off a vent hole 44 near the upper end of the suction tube so that the vacuum applied to the cuvette will work effectively to draw specimen liquid up through the lumen 43a of the suction tube, and so that air will not be entrained in the liquid sample.

### Sample Metering

A small percentage of patient specimens, as may be found in gynecological Pap test and other specimen types, contain large clusters of cells, artifacts, and/or cellular or noncellular debris. Some of these large objects, if collected and deposited with a slide-mounted cellular sample, can obscure the visualization of diagnostic cells and, consequently, result in a less accurate interpretation or diagnosis of the slide sample. Since most of these features are not of diagnostic relevance, their elimination from the sample is, in general, desirable. It is also desirable to eliminate such large objects from liquid specimens collected in cuvettes. To achieve this result, close control of the bottom inlets to the suction tube 43 is maintained, as follows.

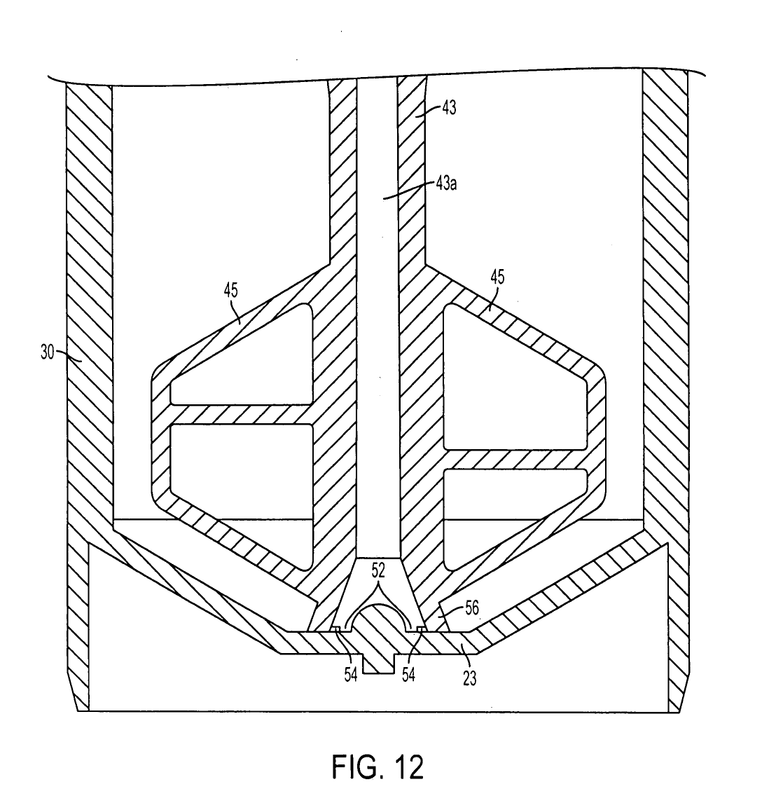

Referring to FIGS. 7, 8, 9 and 12, the bottom end of suction tube 43 is provided with a plurality of standoffs in the form of peripherally spaced feet 52 that contact the bottom wall 23 of the container to define a plurality of peripherally spaced inlets 54 to the tube. This interface effectively forms a plurality of metering valves. Proper sizing and spacing of the feet 52 (and therefore the inlets 54) prevents large objects from entering the suction tube 43, while allowing the passage of smaller objects that may be diagnostically useful. The minimum dimension of the cross-section of any inlet (as well as the minimum height of any foot) for cytology specimens preferably is in the range of about 0.004 in. to about 0.020 in. For gynecological specimens, the minimum height of any foot (or any inlet) preferably is about 0.010 in. For non-cytology specimens the preferred minimum inlet size will depend on the size distribution of the particulates in the specimen.

While the inlets 54 have a thin (low) passage section as illustrated and a small metering area, clogging is not an issue due to the relatively wide dimension. Having a plurality of inlets ensures that liquid flow will not be interrupted because, should one inlet become clogged, others will accommodate the flow. Further, because the bottom end of the tube is flared outwardly at 56, a net larger inlet area is formed to help the liquid bypass any clogged inlets. Eight feet (defining eight inlets) are shown in the figures, but a different number of feet may be used—two at a minimum. Although squared-off feet are shown, the feet could have rounded inside corners, and/or could have rounded outside corners. Regardless of the number or shape of the feet, minimum inlet size preferably should fall within the above cross-section range of about 0.004 in. to about 0.020 in for cytology specimens.

Substantial contact of the tube with the bottom wall 23 of the container is important. To that end, aspiration tube 43 is dimensioned such that, when the aspiration head engages the stirrer with a downward force, the feet 52 will firmly contact bottom wall 23, which can flex downwardly if necessary depending on manufacturing tolerances.

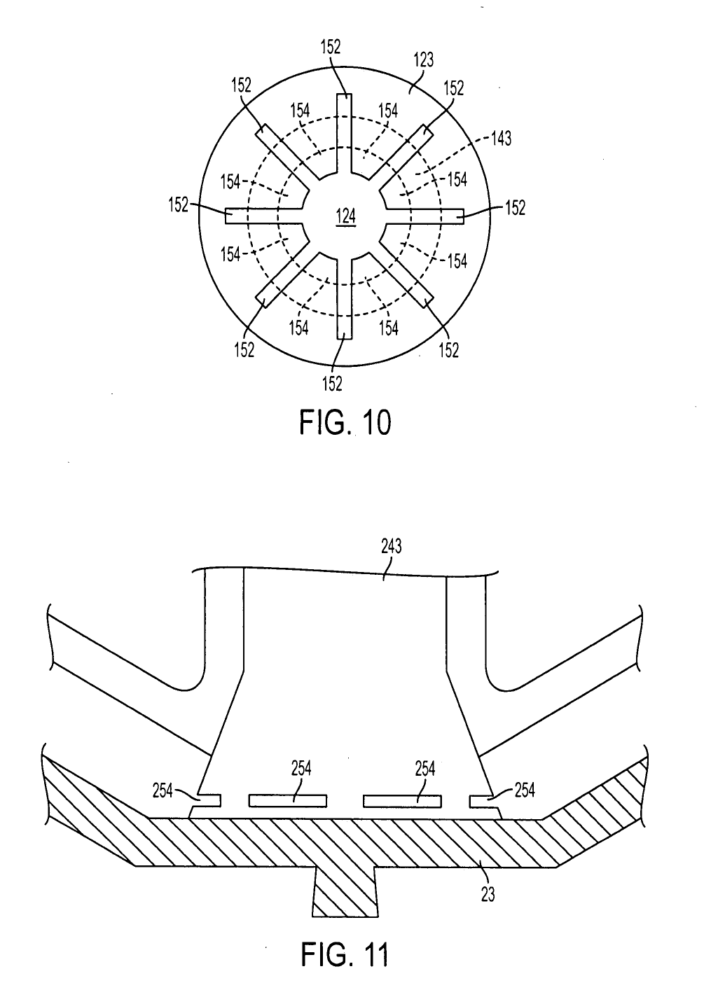

The objective is to draw specimen liquid from the lowest part of the container, where particulates may settle even after vigorous mixing, while metering to prevent the passage of particulates larger than a specified threshold. Other inlet-defining structural arrangements at the interface between the bottom end of suction tube 43 and bottom wall 23 may be used to accomplish this. For example, the bottom end of tube 43 may be smooth (i.e., have no feet), while the bottom wall 23 may have standoffs against which the end of tube 43 rests. FIG. 10 shows an example of this arrangement, in which bottom wall 123 is provided with integrally molded, upstanding, radial ribs 152. The annular bottom end face 143 of the suction tube is shown in dashed lines superposed above the ribs 152. Here, eight ribs 152 are shown radiating from a central boss 124, the ribs and the end of the suction tube defining eight inlets 154. Ribs or standoffs of different shape (e.g., curved), number and/or configuration could also be used as long as they cooperate with the bottom end of the suction tube to define a plurality of inlets of proper size.

Alternatively, standoffs could be provided on both the bottom end of the suction tube and the bottom of the container, the standoffs cooperating to define a plurality of inlets of the required size. However, inasmuch as such an arrangement could interfere with rotation of the processing assembly (stirrer) during mixing, it is better left to embodiments in which the processing assembly does not rotate, with mixing effected by some other instrumentality (see below).

In lieu of structures that define inlets between the bottom end of the suction tube and bottom wall 23 of the container, the suction tube may have a plurality of peripherally spaced orifices located immediately adjacent the bottom end of the tube. FIG. 11 shows an example of these orifices as elongated openings 254 in suction tube 243; other shapes (not shown) may also be used. Regardless of the inlet arrangement, minimum inlet size preferably should fall within the above cross-section range of about 0.004 in. to about 0.020 in. for cytology specimens.

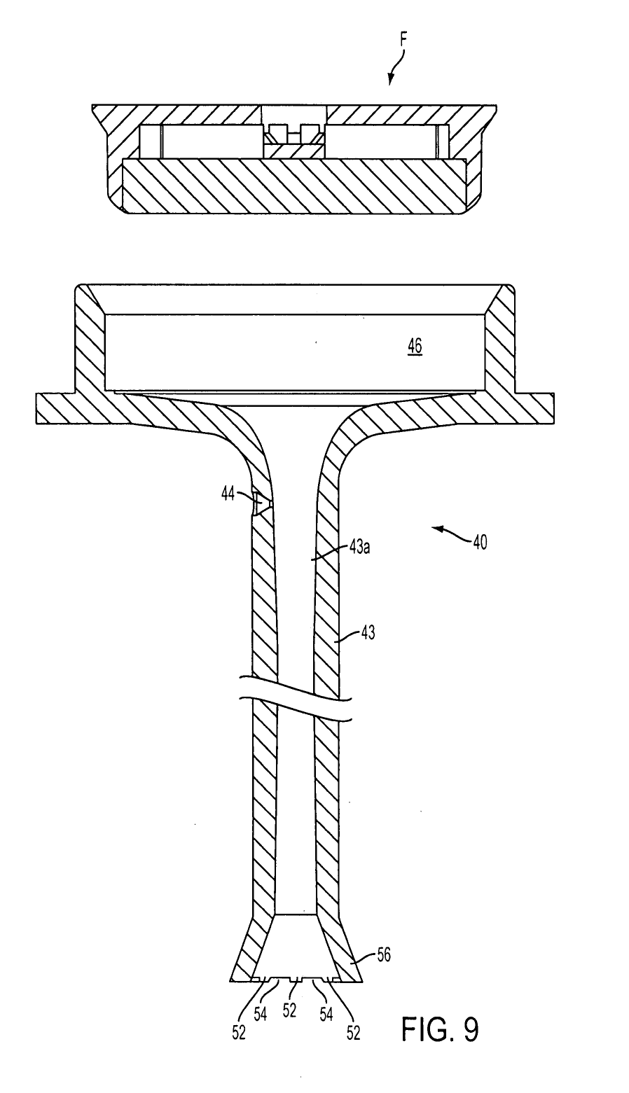

While a rotatable processing assembly 40 with mixing vanes 45 has been disclosed, it will be appreciated that specimen mixing could be accomplished without rotation of the processing assembly by using other known types of agitating arrangements. For example, vibratory energy could be applied to the upper portion of a processing assembly having mixing elements that are suitably designed to impart such energy efficiently to the specimen liquid. As another example, vibratory energy could be imparted to the container 20 when appropriately supported, and the processing assembly may be devoid of mixing elements or have mixing elements that enhance the vibrational mixing. As yet another example, ferromagnetic beads could be incorporated in the vial (e.g., at the factory), and these beads would be caused to move throughout the specimen under the influence of a moving magnetic field imposed, e.g., by a rotating magnet located beneath the vial. Such beads would remain in the vial during sampling because the metering feature of the invention, described above, would prevent the beads from becoming entrained in the liquid sample as it is removed from the container. In such an embodiment, the processing assembly could have no mixing elements, or small mixing elements that cooperate with the beads to enhance mixing. Regardless of the type of mixing arrangement used, the processing assembly, in order to be useful for making slide-mounted samples, would have an upper portion with a manifold 46 for receiving a filter assembly F (see FIG. 9), and a suction tube 43 that preferably meters the sample flow of specimen liquid from the bottom of the container.

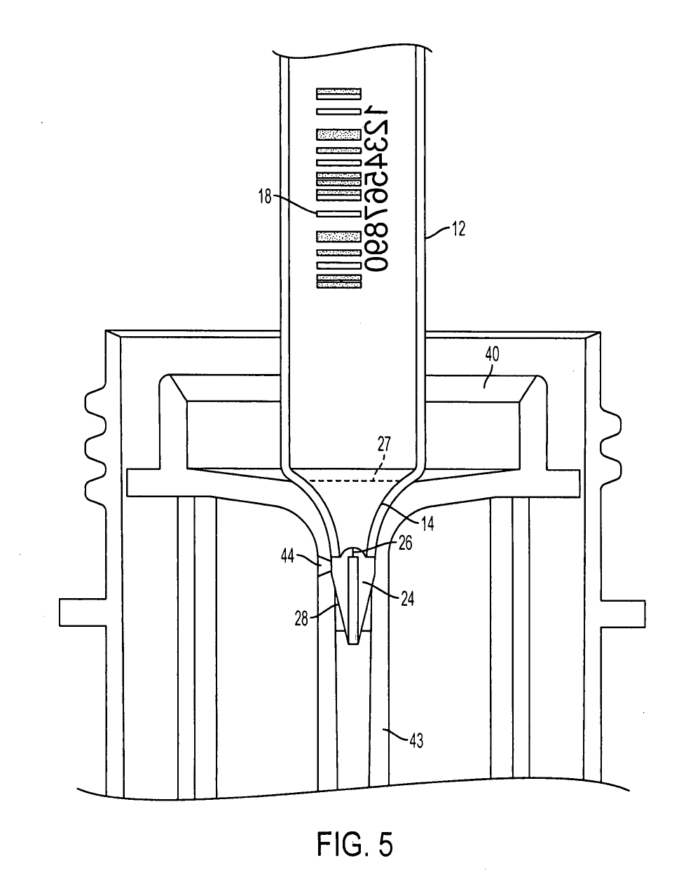

Additional metering for liquid samples optionally may be provided by at least one flow-metering passage in the cuvette itself. This may be needed if, for example, the flow metering afforded at the bottom of the processing assembly is not restrictive enough for liquid sampling purposes. The flow-metering passage can take any suitable form. As an example, a filter 27 of any suitable type (shown in dashed lines in FIG. 5) may be located just inside the inlet flow passage 26 to form a barrier to incoming particulates that exceed the size of the filter pores, keeping such particulates from entering the collection chamber within the cuvette.

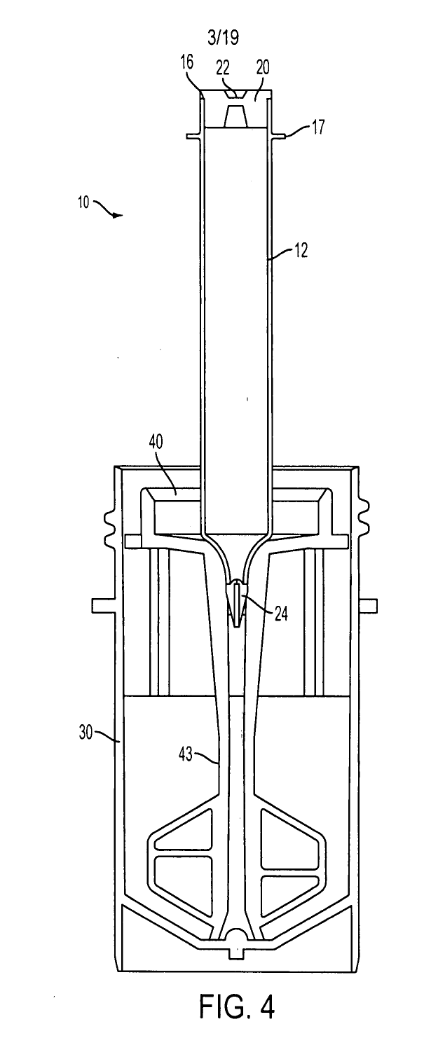

In terms of liquid sampling as a separate operation, it should be noted that the invention in its broadest aspects does not require specimen premixing, or any type of specimen preprocessing. Nor does it require the use of specimen vials that come prepackaged with the special internal processing assembly (stirrer) 40 shown in FIG. 4. Accordingly, it is possible to carry out the liquid sampling operation of the invention by making use of any arrangement that provides a discharge passage through which liquid can flow upwardly from the specimen container to a receptacle (cuvette).

For example, the discharge passage can be the lumen of a tube that is placed in the specimen container at or shortly before the time the liquid sampling operation is to take place. Such a tube optionally may be provided with stabilizing/positioning elements; and it may be provided with any type of flow-metering arrangement, such as an internal restriction or any of the arrangements described above; or with no flow-metering arrangement at all. In either case, the cuvette may be provided with its own flow-metering arrangement, as described above, as either the sole or a supplemental metering arrangement. As another example, the discharge passage could be associated with the container wall. It could be a separate tubular element supported by the container wall, or an integral part of the container itself, such as hollow tubular boss or other tubular structure formed as part of the container wall, with or without a flow-metering arrangement (which in any case may be provided in the cuvette).

### Cuvette Handling

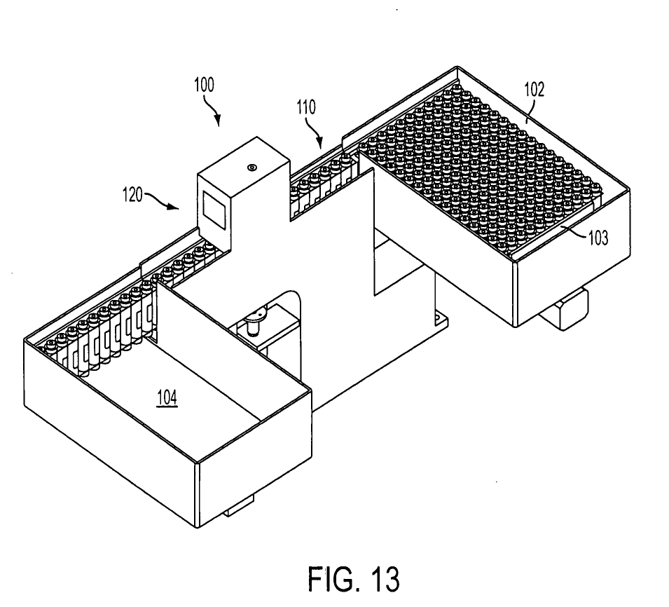

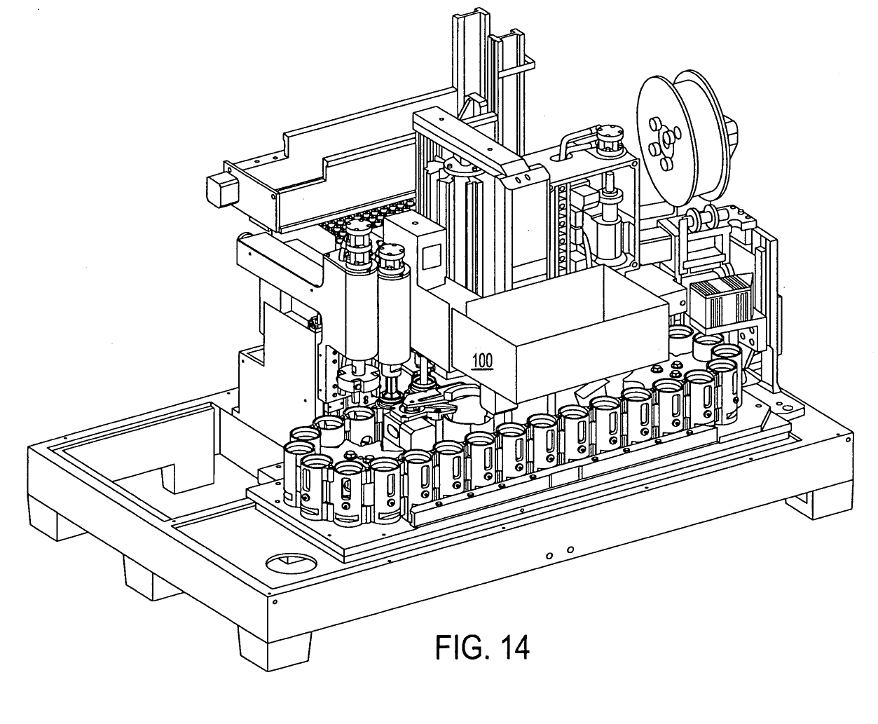

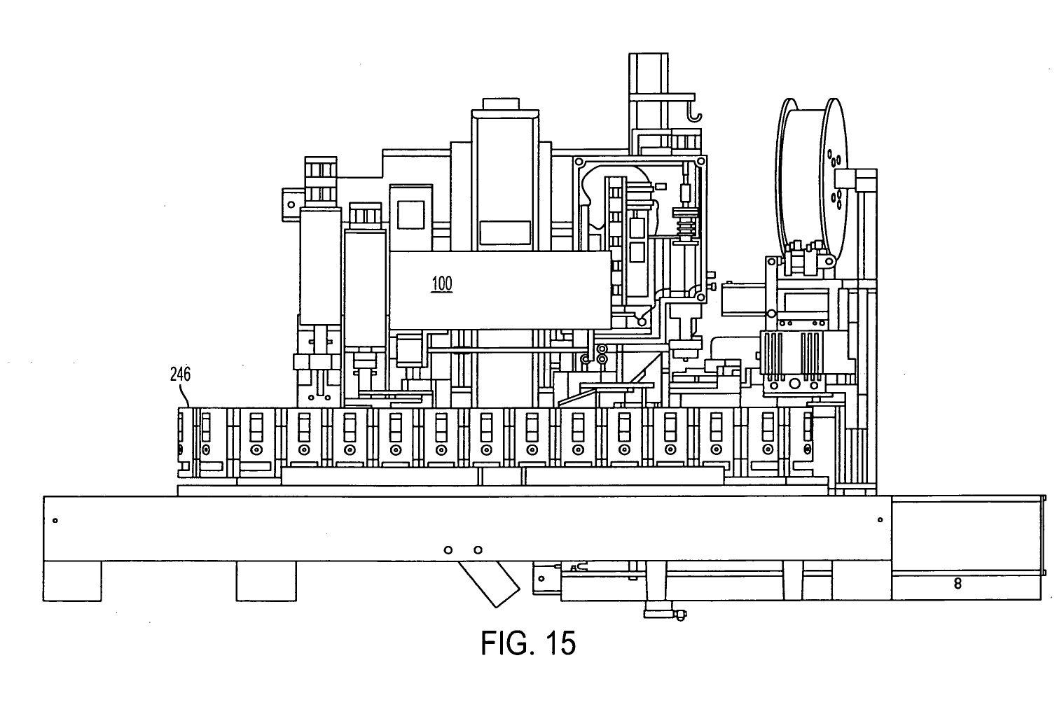

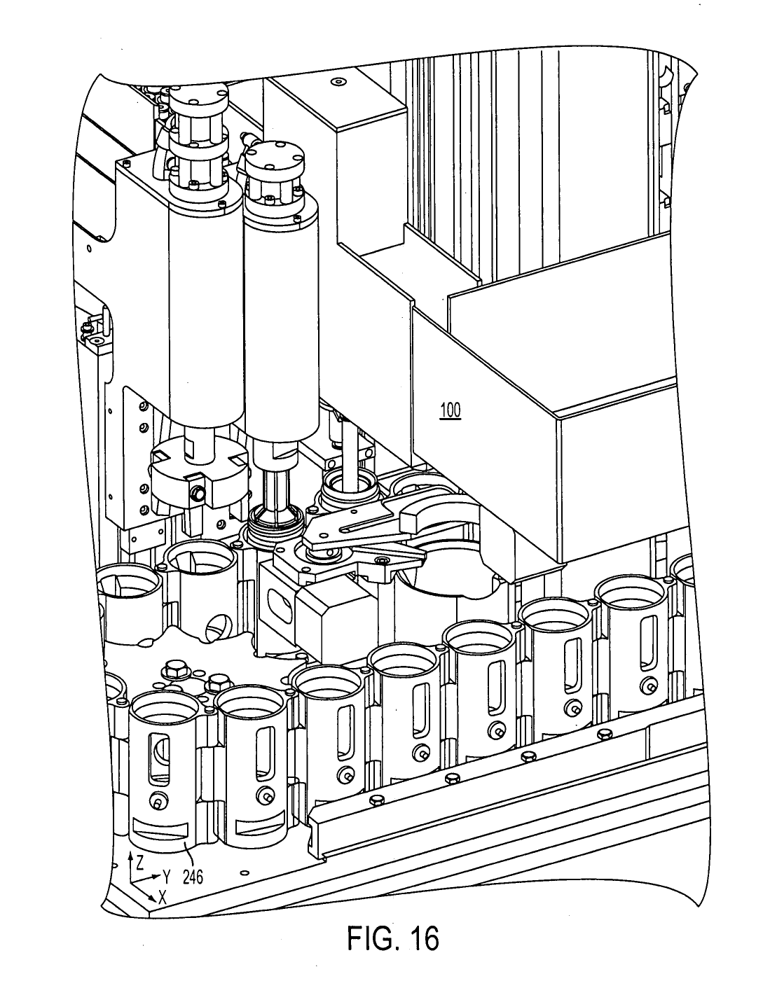

The liquid sampling draw station 100 is shown in FIG. 13, separated from the rest of the LBP processor. Draw station 100 is mounted in a common housing and has the following main components: (1) a feeder tray 102 for housing fresh (empty) cuvettes (tray 102 may include a spring-loaded pusher plate 103 for urging cuvettes toward the feeding end of the tray); (2) a receiver tray 104 for housing used (filled) cuvettes; (3) a transport mechanism 110 for transporting cuvettes from feeder tray 102, across the path of the conveyor of the LBP processor, to receiver tray 104; and (4) a docking mechanism 120 for removing one cuvette at a time from the transport path, docking it with the processing assembly of a specimen vial, and returning it to the transport path. FIGS. 14-16 show the liquid sampling draw station 100 installed in the LBP processor.

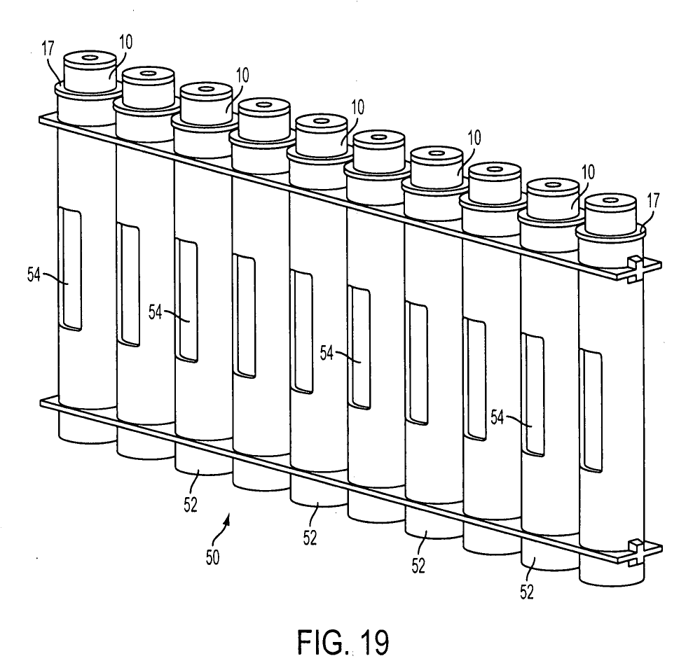

Referring to FIGS. 19 and 21, cuvettes 10 are loaded into feeder tray 102 in groups of ten carried by clips 50. Each clip has ten sleeves 52, one for each cuvette, and each sleeve has a window 54 through which the cuvette bar code can be read by a bar code reader (not shown). Each cuvette is retained in a sleeve 52 by means of its collar 17, which rests on the upper end of the sleeve, and can be lifted out of the clip by the docking mechanism. Clips are fed out of feeder tray 102 by a clip magazine feeder (not shown), which comprises a walking-beam type feed mechanism actuated by air cylinders.

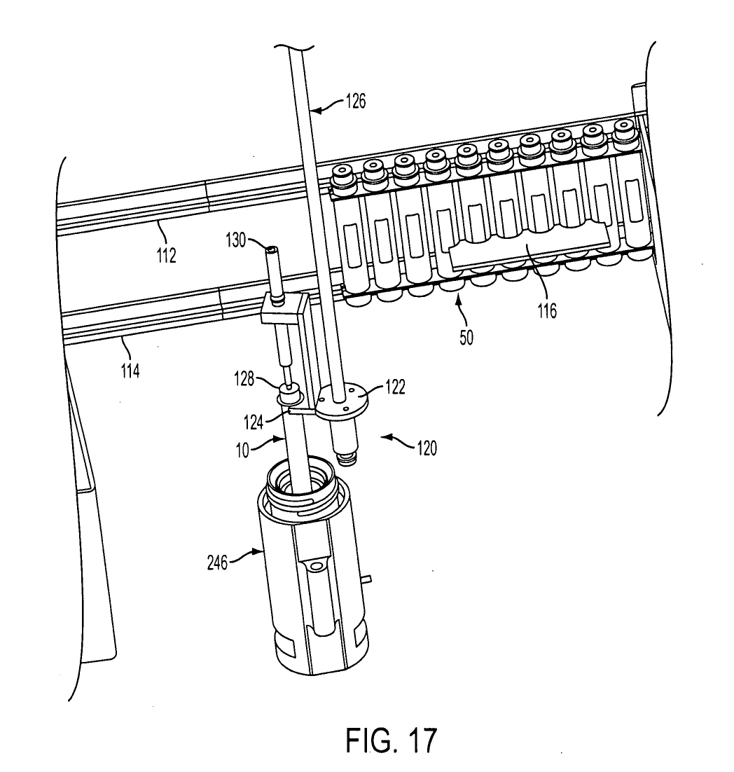

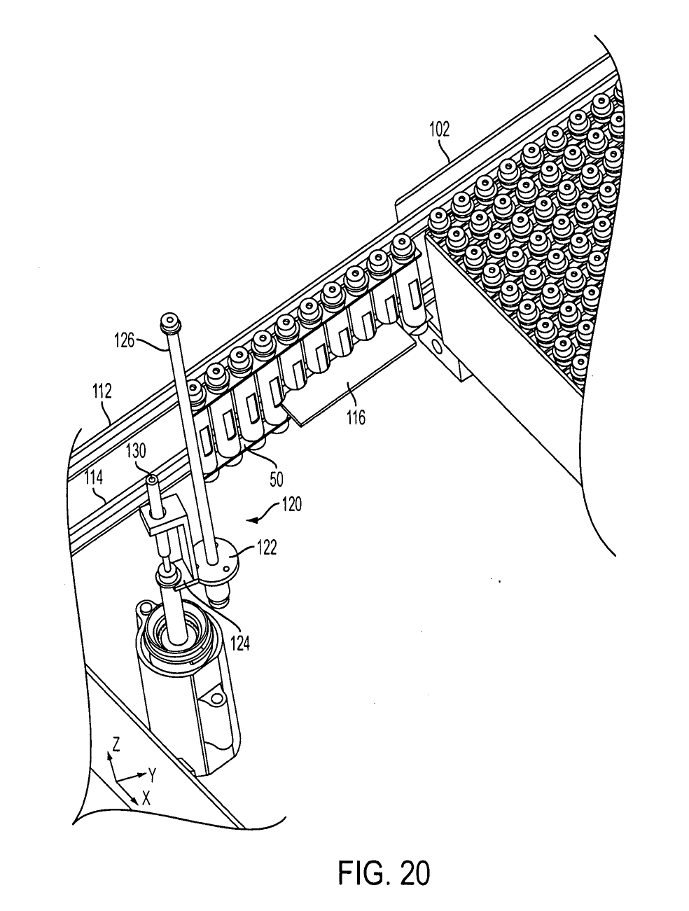

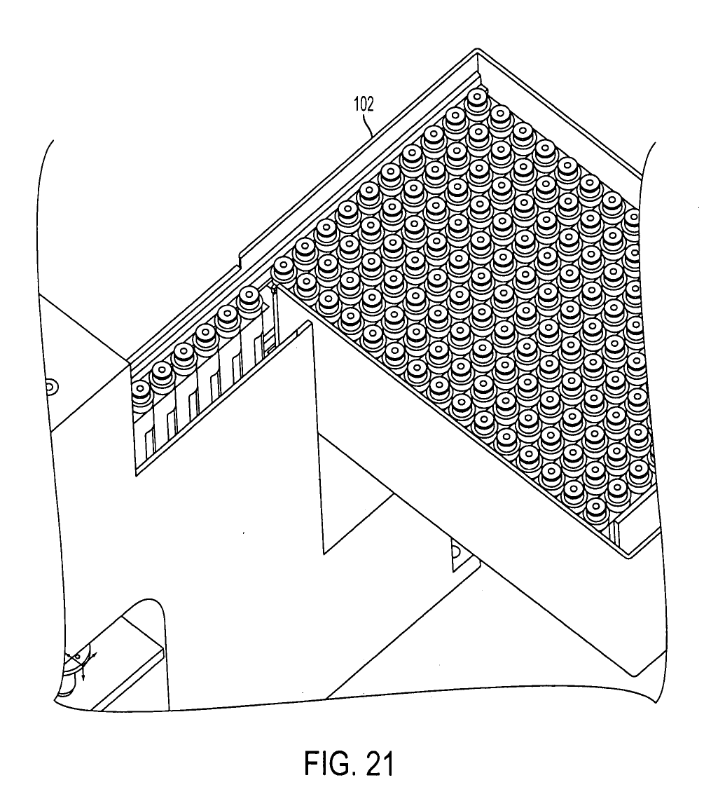

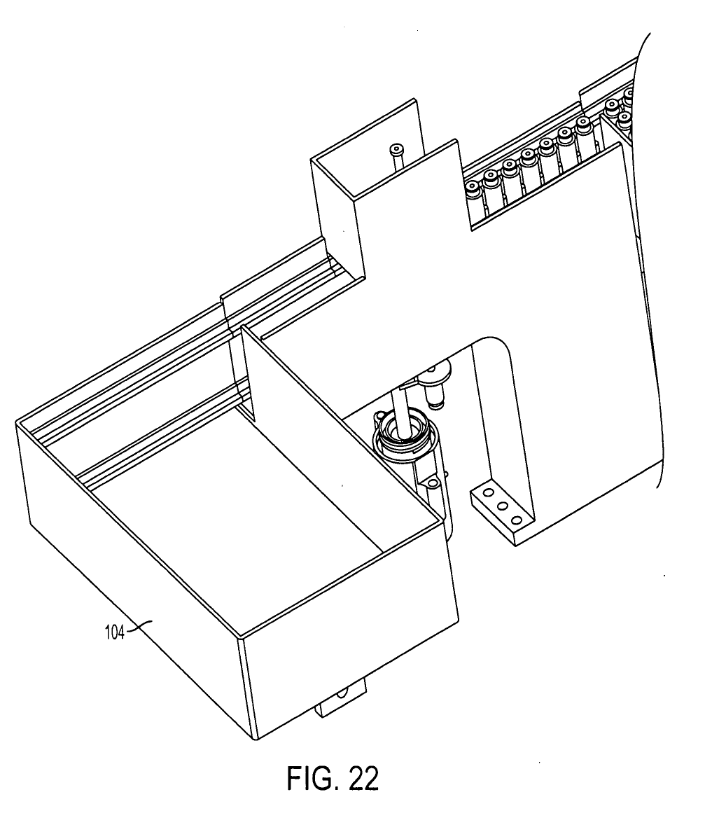

Portions of the transport mechanism 110 are shown in FIGS. 17 and 20. Upper and lower rails 112, 114 guide cuvette clips 50 from the feeder tray 102 to the receiver tray 104. A notched advancing plate 116 is mounted for lateral movement (parallel to rails 112, 114), and for oscillating movement toward and away from the rails, by means of an escapement mechanism (not shown). Advancing plate 116 thus engages a clip 50 to move it stepwise (i.e., one cuvette at a time) as instructed by the controller of the LBP processor. Clips of cuvettes are processed in a seamless operation as they are presented by the clip magazine feeder.

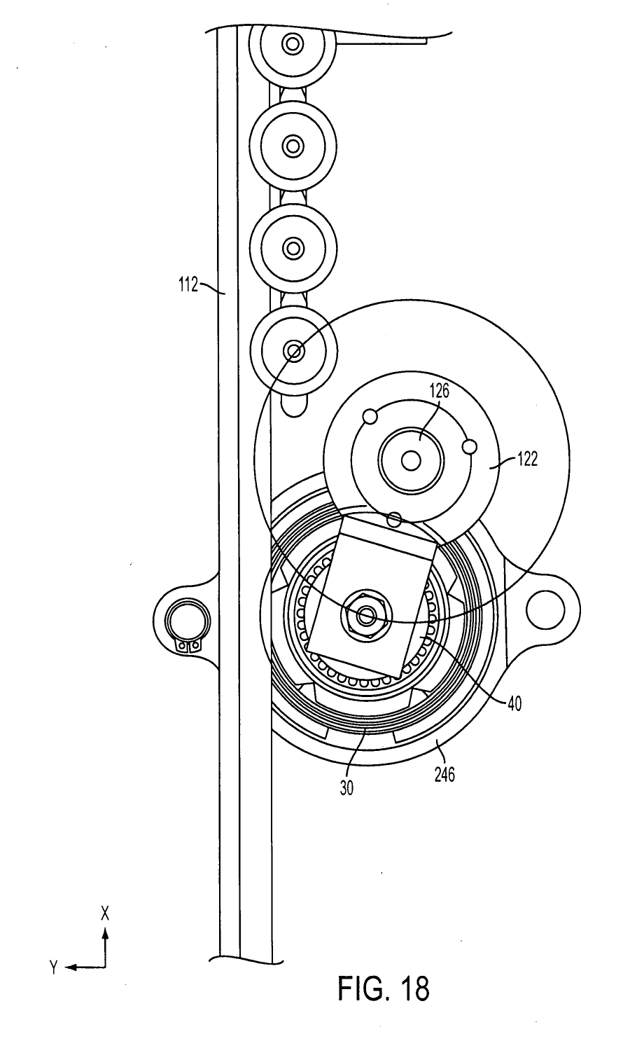

Portions of the docking mechanism 120 are shown in FIGS. 17, 18 and 20. Cuvettes are shuttled from the clip position to the docking (aspiration) position and back to the clip position by the action of a Theta- and Z-axis robotic arm 122. Movement along these two axes is effected by step motors (not shown) through a commercial screw rail 126 as the base mechanism. Arm 122 has a gripper 124 adapted to releasably grip the upper end of a cuvette beneath collar 17, lift it out of the clip, move it to the docking position, and then move it back to the clip after sample acquisition. A retractable, pneumatically-actuated cannula 128 is mounted to arm 122 and is connected to a vacuum line 130.

In operation, the robotic arm 122 will move to the clip position where the gripper 124 engages and locks on the cuvette to be processed. Cannula 128 will then pierce the stopper membrane 22 to a fixed distance. At this point, the Z axis motor will extract the cuvette from the clip 50 and transfer it to the aspiration position, where it will come into contact with the processing assembly (stirrer) 40 in the specimen vial. A seal will be formed between the stirrer suction tube 43 and the cuvette's one-way valve 24. Liquid will then be aspirated into the cuvette by vacuum forces. Aspiration will continue until a liquid-level sensor indicates a programmed acceptance level. At that point, aspiration will be suspended and the cuvette will be returned to the clip.

The capacity of feeder tray 102 can be tailored to suit processing needs. Additional clips of cuvettes can be added to the feeder tray 102 at any time in the processing operation. Clips are processed on a first-in, first-out sequence. Seamless integration with the LBP processor ensures efficient and reliable operation.

### INDUSTRIAL APPLICABILITY

The invention thus provides an efficient, convenient, safe and effective system and method for collecting, handling and processing biological specimens and other specimens of particulate matter-containing liquid. Although not restricted to automated use, it is ideally suited for use in automated equipment that provides consistently reliable processing tailored to sample-specific needs. Such equipment may be part of a complete diagnostic laboratory system.

1. A method for obtaining a liquid sample from a particulate matter-containing liquid specimen in a container, the liquid sample containing size-restricted particulate matter, the method comprising the steps of:
providing a receptacle having a chamber for collecting the liquid sample, the receptacle having an inlet;
providing a discharge passage through which liquid can flow upwardly from the container to the receptacle, the discharge passage having an upper discharge port and at least one intake submerged in the liquid in the container;
providing at least one flow-metering passage associated with the discharge passage or the receptacle, the flow-metering passage preventing particulate matter above a predetermined size from passing into the receptacle chamber;
placing the receptacle inlet in liquid-tight communication with the discharge port; and
causing particulate matter-containing liquid to flow from the container upwardly through the discharge passage, through the receptacle inlet and into the receptacle chamber, the flowing liquid also passing through the flow-metering passage so that the liquid sample collected in the receptacle contains only size-restricted particulate matter.

2. A method according to claim 1, wherein the step of causing particulate matter-containing liquid to flow from the container to the receptacle chamber comprises creating a pressure differential across the receptacle inlet such that the pressure in the receptacle chamber is less than the pressure in the container.

3. A method according to claim 2, wherein the step of creating a pressure differential comprises applying a vacuum to the receptacle chamber.

4. A method according to claim 2, wherein the inlet is in a resilient tip on the receptacle, the resilient tip is adapted to fit into and form a seal with the discharge port, and the resilient tip comprises a one-way valve that is pressure-actuated to permit fluid flow into the interior of the receptacle when the pressure in the receptacle is less than the pressure outside the receptacle at the inlet, and prevents outflow of fluid from the receptacle under the influence of any other relative pressure conditions; and wherein the step of placing the receptacle in liquid-tight communication with the discharge port comprises inserting the resilient tip into the discharge port to form a seal with the discharge port.

5. A method according to claim 1, wherein the discharge passage comprises the lumen of a tube, and the tube has a vent hole in communication with the lumen of the tube below and close to the discharge port; and wherein the step of placing the receptacle in liquid-tight communication with the discharge port comprises inserting the portion of the receptacle having the inlet into the discharge port to form a seal with the discharge port and to seal off the vent hole.

6. A method according to claim 5, wherein the inlet is in a resilient tip on the receptacle and the resilient tip comprises a one-way valve that is pressure-actuated to permit fluid flow into the interior of the receptacle when the pressure in the receptacle is less than the pressure outside the receptacle at the inlet, and prevents outflow of fluid from the receptacle under the influence of any other relative pressure conditions; and wherein the step of placing the receptacle in liquid-tight communication with the discharge port comprises inserting the resilient tip into the discharge port to form a seal with the discharge port and to seal off the vent hole.

7. A method according to claim 6, wherein the step of causing specimen liquid to flow upwardly through the discharge passage and into the receptacle inlet comprises creating a pressure differential across the receptacle inlet such that the pressure in the receptacle is less than the pressure in the container.

8. A system for obtaining a liquid sample from a particulate matter-containing liquid specimen in a container, the liquid sample containing size-restricted particulate matter, the system comprising:
a receptacle having a chamber for collecting the liquid sample, the receptacle having an inlet;
a discharge element associated with the container and through which liquid can flow upwardly from the container to the receptacle, the discharge element having a discharge passage with an upper discharge port and at least one intake submerged in the liquid in the container; and
at least one flow-metering passage associated with the discharge passage or the receptacle, the flow-metering passage preventing particulate matter above a predetermined size from passing into the receptacle chamber so that the liquid sample collected in the receptacle chamber contains only size-restricted particulate matter;
wherein the receptacle inlet and the discharge port are adapted to releasably and sealingly mate to allow specimen liquid to flow from the container to the receptacle chamber.

9. A system according to claim 8, wherein the inlet is in a resilient tip on the receptacle, and the resilient tip is adapted to fit into and form a seal with the discharge port.

10. A system according to claim 9, wherein the resilient tip comprises a one-way valve that is pressure-actuated to permit fluid flow into the interior of the receptacle when the pressure in the receptacle is less than the pressure outside the receptacle at the inlet, and prevents outflow of fluid from the receptacle under the influence of any other relative pressure conditions.

11. A system according to claim 8, wherein the discharge element comprises a tube, the discharge passage comprises the lumen of the tube, and the tube has a vent hole in communication with the lumen of the tube below and close to the discharge port; and wherein the portion of the receptacle having the inlet is adapted to fit into and form a seal with the discharge port, and seal off the vent hole.

12. A system according to claim 11, wherein the inlet is in a resilient tip on the receptacle, and the resilient tip is adapted to fit into and form a seal with the discharge port, and seal off the vent hole.

13. A system according to claim 12, wherein the resilient tip comprises a one-way valve that is pressure-actuated to permit fluid flow into the interior of the receptacle when the pressure in the receptacle is less than the pressure outside the receptacle at the inlet, and prevents outflow of fluid from the receptacle under the influence of any other relative pressure conditions.

14. A method for obtaining a liquid sample from a particulate matter-containing liquid specimen in a container, the liquid sample containing size-restricted particulate matter, the method comprising the steps of:
providing a receptacle for collecting the liquid sample, the receptacle having an inlet;
providing a discharge passage through which liquid can flow upwardly from the container to the receptacle, the discharge passage having an upper discharge port and at least one flow-metering intake submerged in the liquid in the container and through which liquid containing only size-restricted particulate matter can enter the discharge passage;
placing the receptacle inlet in liquid-tight communication with the discharge port; and
causing liquid containing size-restricted particulate matter to flow upwardly through the discharge passage and into the receptacle.

15. A method according to claim 14, wherein the at least one flow-metering intake is disposed at or near the bottom of the container so that the liquid sample is drawn from the bottom of the specimen.

16. A method according to claim 14, wherein the discharge passage has a plurality of flow-metering intakes.

17. A method according to claim 16, wherein the flow-metering intakes are disposed at or near the bottom of the container so that the liquid sample is drawn from the bottom of the specimen.

18. A method according to any one of claims 14 through 17, wherein the step of causing liquid containing size-restricted particulate matter to flow upwardly through the discharge passage and into the receptacle comprises creating a pressure differential across the receptacle inlet such that the pressure in the receptacle is less than the pressure in the container.

19. A method according to claim 18, wherein the step of creating a pressure differential comprises applying a vacuum to the receptacle.

20. A method according to claim 18, wherein the inlet is in a resilient tip on the receptacle, the resilient tip is adapted to fit into and form a seal with the discharge port, and the resilient tip comprises a one-way valve that is pressure-actuated to permit fluid flow into the interior of the receptacle when the pressure in the receptacle is less than the pressure outside the receptacle at the inlet, and prevents outflow of fluid from the receptacle under the influence of any other relative pressure conditions; and wherein the step of placing the receptacle in liquid-tight communication with the discharge port comprises inserting the resilient tip into the discharge port to form a seal with the discharge port.

21. A method according to claim 14, wherein the discharge passage comprises the lumen of a tube, and the tube has a vent hole in communication with the lumen of the tube below and close to the discharge port; and wherein the step of placing the receptacle in liquid-tight communication with the discharge port comprises inserting the portion of the receptacle having the inlet into the discharge port to form a seal with the discharge port and to seal off the vent hole.

22. A method according to claim 21, wherein the inlet is in a resilient tip on the receptacle and the resilient tip comprises a one-way valve that is pressure-actuated to permit fluid flow into the interior of the receptacle when the pressure in the receptacle is less than the pressure outside the receptacle at the inlet, and prevents outflow of fluid from the receptacle under the influence of any other relative pressure conditions; and wherein the step of placing the receptacle in liquid-tight communication with the discharge port comprises inserting the resilient tip into the discharge port to form a seal with the discharge port and to seal off the vent hole.

23. A method according to claim 22, wherein the step of causing liquid containing size-restricted particulate matter to flow upwardly through the discharge passage and into the receptacle comprises creating a pressure differential across the receptacle inlet such that the pressure in the receptacle is less than the pressure in the container.

24. A system for obtaining a liquid sample from a particulate matter-containing liquid specimen in a container, the liquid sample containing size-restricted particulate matter, the system comprising:
a receptacle for collecting the liquid sample, the receptacle having an inlet; and
a discharge element associated with the container and through which liquid can flow upwardly from the container to the receptacle, the discharge element having a discharge passage with an upper discharge port and at least one flow-metering intake submerged in the liquid in the container and through which liquid containing only size-restricted particulate matter can enter the discharge passage;
wherein the receptacle inlet and the discharge port are adapted to releasably and sealingly mate to allow sample liquid to flow into the receptacle.

25. A system according to claim 24, wherein the discharge element has a plurality of flow-metering intakes.

26. A system according to claim 25, wherein the flow-metering intakes are disposed at or near the bottom of the container.

27. A system according to claim 26, wherein the discharge element comprises a tube, the discharge passage comprises the lumen of the tube, and the flow-metering intakes are located around the periphery of the tube at or immediately adjacent the bottom end of the tube.

28. A system according to claim 27, wherein the bottom end of the tube is open, and the bottom end of the tube and the bottom wall of the container are configured to form a plurality of discrete contact areas at their interface and a plurality of discrete flow-metering intakes between the contact areas.

29. A system according to claim 28, wherein at least one of the bottom end of the tube and the bottom wall of the container has a plurality of standoffs contacting the other.

30. A system according to claim 29, wherein the standoffs comprise peripherally spaced feet on the bottom end of the tube that contact the bottom wall of the container.

31. A system according to claim 30, wherein the bottom end of the tube is flared outwardly.

32. A system according to claim 27, wherein the tube has a vent hole in communication with the lumen of the tube below and close to the discharge port, and the portion of the receptacle having the inlet is adapted to fit into and form a seal with the discharge port, and seal off the vent hole.

33. A system according to claim 32, wherein the inlet is in a resilient tip on the receptacle, and the resilient tip is adapted to fit into and form a seal with the discharge port, and seal off the vent hole.

34. A system according to claim 33, wherein the resilient tip comprises a one-way valve that is pressure-actuated to permit fluid flow into the interior of the receptacle when the pressure in the receptacle is less than the pressure outside the receptacle at the inlet, and prevents outflow of fluid from the receptacle under the influence of any other relative pressure conditions.

35. A system according to any one of claims 24 through 27, wherein the inlet is in a resilient tip on the receptacle, and the resilient tip is adapted to fit into and form a seal with the discharge port.

36. A system according to claim 35, wherein the resilient tip comprises a one-way valve that is pressure-actuated to permit fluid flow into the interior of the receptacle when the pressure in the receptacle is less than the pressure outside the receptacle at the inlet, and prevents outflow of fluid from the receptacle under the influence of any other relative pressure conditions.

37. A system according to claim 24, wherein the discharge element comprises a tube, the discharge passage comprises the lumen of the tube, and the tube has a vent hole in communication with the lumen of the tube below and close to the discharge port; and wherein the portion of the receptacle having the inlet is adapted to fit into and form a seal with the discharge port, and seal off the vent hole.

38. A system according to claim 37, wherein the inlet is in a resilient tip on the receptacle, and the resilient tip is adapted to fit into and form a seal with the discharge port, and seal off the vent hole.

39. A system according to claim 38, wherein the resilient tip comprises a one-way valve that is pressure-actuated to permit fluid flow into the interior of the receptacle when the pressure in the receptacle is less than the pressure outside the receptacle at the inlet, and prevents outflow of fluid from the receptacle under the influence of any other relative pressure conditions.

40. A method for obtaining a liquid sample from a particulate matter-containing liquid specimen in a container, the liquid sample containing size-restricted particulate matter, the method comprising the steps of:
providing a receptacle for collecting the liquid sample, the receptacle having an inlet and at least one flow-metering passage which prevents passage of particulate matter above a predetermined size;
providing a discharge passage through which liquid can flow upwardly from the container to the receptacle, the discharge passage having an upper discharge port and at least one intake submerged in the liquid in the container;
placing the receptacle inlet in liquid-tight communication with the discharge port; and
causing specimen liquid to flow upwardly through the discharge passage and through the receptacle inlet to the flow-metering passage, which prevents passage of particulate matter above a predetermined size, whereby the liquid sample collected in the receptacle contains only size-restricted particulate matter.

41. A method according to claim 40, wherein the step of causing specimen liquid to flow upwardly through the discharge passage and into the receptacle inlet comprises creating a pressure differential across the receptacle inlet such that the pressure in the receptacle is less than the pressure in the container.

42. A method according to claim 41, wherein the step of creating a pressure differential comprises applying a vacuum to the receptacle.

43. A method according to claim 41, wherein the inlet is in a resilient tip on the receptacle, the resilient tip is adapted to fit into and form a seal with the discharge port, and the resilient tip comprises a one-way valve that is pressure-actuated to permit fluid flow into the interior of the receptacle when the pressure in the receptacle is less than the pressure outside the receptacle at the inlet, and prevents outflow of fluid from the receptacle under the influence of any other relative pressure conditions; and wherein the step of placing the receptacle in liquid-tight communication with the discharge port comprises inserting the resilient tip into the discharge port to form a seal with the discharge port.

44. A method according to claim 40, wherein the discharge passage comprises the lumen of a tube, and the tube has a vent hole in communication with the lumen of the tube below and close to the discharge port; and wherein the step of placing the receptacle in liquid-tight communication with the discharge port comprises inserting the portion of the receptacle having the inlet into the discharge port to form a seal with the discharge port and to seal off the vent hole.

45. A method according to claim 44, wherein the inlet is in a resilient tip on the receptacle and the resilient tip comprises a one-way valve that is pressure-actuated to permit fluid flow into the interior of the receptacle when the pressure in the receptacle is less than the pressure outside the receptacle at the inlet, and prevents outflow of fluid from the receptacle under the influence of any other relative pressure conditions; and wherein the step of placing the receptacle in liquid-tight communication with the discharge port comprises inserting the resilient tip into the discharge port to form a seal with the discharge port and to seal off the vent hole.

46. A method according to claim 45, wherein the step of causing specimen liquid to flow upwardly through the discharge passage and into the receptacle inlet comprises creating a pressure differential across the receptacle inlet such that the pressure in the receptacle is less than the pressure in the container.

47. A system for obtaining a liquid sample from a particulate matter-containing liquid specimen in a container, the liquid sample containing size-restricted particulate matter, the system comprising:
a receptacle for collecting the liquid sample, the receptacle having an inlet and at least one flow-metering passage which prevents passage of particulate matter above a predetermined size so that the liquid sample collected in the receptacle contains only size-restricted particulate matter; and
a discharge element associated with the container and through which liquid can flow upwardly from the container to the receptacle, the discharge element having a discharge passage with an upper discharge port and at least one intake submerged in the liquid in the container;
wherein the receptacle inlet and the discharge port are adapted to releasably and sealingly mate to allow specimen liquid to flow from the container to the receptacle.

48. A system according to claim 47, wherein the flow-metering passage comprises a filter.

49. A system according to claim 47, wherein the inlet is in a resilient tip on the receptacle, and the resilient tip is adapted to fit into and form a seal with the discharge port.

50. A system according to claim 49, wherein the resilient tip comprises a one-way valve that is pressure-actuated to permit fluid flow into the interior of the receptacle when the pressure in the receptacle is less than the pressure outside the receptacle at the inlet, and prevents outflow of fluid from the receptacle under the influence of any other relative pressure conditions.

51. A system according to claim 47, wherein the discharge element comprises a tube, the discharge passage comprises the lumen of the tube, and the tube has a vent hole in communication with the lumen of the tube below and close to the discharge port; and wherein the portion of the receptacle having the inlet is adapted to fit into and form a seal with the discharge port, and seal off the vent hole.

52. A system according to claim 51, wherein the inlet is in a resilient tip on the receptacle, and the resilient tip is adapted to fit into and form a seal with the discharge port, and seal off the vent hole.

53. A system according to claim 52, wherein the resilient tip comprises a one-way valve that is pressure-actuated to permit fluid flow into the interior of the receptacle when the pressure in the receptacle is less than the pressure outside the receptacle at the inlet, and prevents outflow of fluid from the receptacle under the influence of any other relative pressure conditions.

54. A method for optionally obtaining a liquid sample and/or a particulate matter sample from a particulate matter-containing liquid specimen in a container, the method using an apparatus comprising a liquid sampling station for collecting a liquid sample in a receptacle having a resilient tip with an inlet, and a specimen acquisition station having an aspiration head for collecting a sample layer of particulate matter separated from the liquid on a surface of a filter, the container having therein a processing assembly comprising an upper separation chamber adapted to receive a filter and a tube extending downwardly from the separation chamber into the specimen liquid in the container, the tube having a vent hole above the level of specimen liquid in the container, the method comprising optionally performing one or both of the following series of steps (a) and/or (b) in either order:
(a) inserting the resilient tip of the receptacle into the upper end of the tube to form a seal with the upper end of the tube and seal off the vent hole, and applying a vacuum to the receptacle to withdraw liquid from the container through the inlet and into the receptacle;
(b) placing a filter in the separation chamber, sealing the aspiration head to the upper portion of the separation chamber, and applying a vacuum to aspirate liquid from the container through the tube and aspirate air into the tube through the vent hole, whereby particulate matter is separated from the aspirated liquid, and a sample layer of particulate matter is formed on a surface of the filter.

55. A method according to claim 54, wherein the apparatus places the sample layer of particulate matter on a slide.

56. A method according to claim 54 or claim 55, wherein the specimen is a biological specimen.

57. A method according to claim 54, wherein series of steps (a) and (b) are performed.

58. A method according to claim 57, wherein series of steps (a) are performed before series of steps (b).

59. A method according to claim 57 or claim 58, wherein the apparatus places the sample layer of particulate matter on a slide.

60. A method according to claim 59, wherein the specimen is a biological specimen.

61. A method for handling receptacles at a liquid sampling station at which liquid can be transferred to the receptacles, each receptacle having a bottom inlet adapted to dock with an upwardly facing port through which liquid can flow, the method comprising the steps of:
providing at least one carrier removably holding a plurality of receptacles;
advancing the carrier along a path that extends toward and away from a liquid transfer location;
removing one receptacle at a time from the carrier, and for each receptacle removed:
moving the receptacle so as to dock the inlet of the receptacle with the port;
moving the receptacle so as to undock the inlet from the port; and
returning the receptacle to the carrier.

62. A method according to claim 61, wherein the receptacle removing and returning steps comprise lifting and lowering the receptacle out of and into the carrier, respectively.

63. A method according to claim 61, wherein the receptacle docking and undocking steps comprise lowering and lifting the receptacle toward and away from the port, respectively.

64. A method according to claim 61, wherein the advancing step comprises advancing the carrier stepwise one receptacle at a time.

65. A method according to claim 64, wherein the carrier is arrested when a receptacle is to be removed from or returned to the carrier.

66. A method according to claim 61, wherein a plurality of carriers are moved along the processing path seriatim.

67. An apparatus for handling receptacles at a liquid sampling station at which liquid can be transferred to the receptacles, each receptacle having a bottom inlet adapted to dock with an upwardly facing port through which liquid can flow, the apparatus comprising:
at least one carrier having a plurality of receptacle locators adapted to removably hold a like number of receptacles;
at least one guide member defining a path of movement for the carrier toward and away from a liquid transfer location;
a carrier-advancing mechanism for moving the carrier along the path;
a gripper releasably engageable with each receptacle in the carrier, and
a multi-axis gripper drive mechanism adapted to move the gripper so that it can remove a receptacle from the carrier, dock the inlet of the receptacle with the port, and return the receptacle to the carrier.

68. An apparatus according to claim 67, wherein the gripper drive mechanism is adapted to lift and lower the gripper so as to enable the receptacle to be lifted from and lowered back into its locator in the carrier, as well as to enable the receptacle inlet to be docked with and undocked from the port.

69. An apparatus according to claim 68, wherein each receptacle locator comprises a sleeve that slidably receives a receptacle.

70. An apparatus according to claim 69, wherein each sleeve has a window through which the receptacle can be viewed.

71. An apparatus according to claim 67, wherein the carrier advancing mechanism is adapted to advance the carrier stepwise, one receptacle at a time.

72. An apparatus according to claim 71, wherein the carrier advancing mechanism is synchronized with the gripper drive mechanism such that the carrier is arrested when the gripper is engaged with a receptacle.

73. An apparatus according to claim 67, comprising a feeder tray adjacent the beginning of the path for holding a plurality of carriers with receptacles, and a receiver tray adjacent the end of the path for holding carriers with receptacles that have been presented to the liquid sampling station, the carrier-advancing mechanism adapted to move carriers from the feeder tray along the path to the receiver tray.
